(19) United States
(12) Patent Application Publication
(10) Pub. No.: US 2002/0073982 A1
(43) Pub. Date: Jun. 20, 2002

(54) Gas-dynamic cold spray lining for aluminum engine block cylinders

(76) Inventors: Furqan Zafar Shaikh, Troy, MI (US); Howard Douglas Blair, Romulus, MI (US); Rodney John Tabaczynski, Northville, MI (US); Tsung-Yu Pan, Ypsilanti, MI (US)

Correspondence Address: Ernest E. Helms, Dykema Gossett PLLC, Suite 300, 1577 North Woodward Avenue, Bloomfield Hills, MI, 48304-2820, US

(21) Appl. No.: 09/739,087

(22) Filed: Dec. 16, 2000

(51) Int. Cl. F02D 41/00; B23P 11/00

(52) U.S. Cl. 123/688; 29/888.06

(57) ABSTRACT

A method and apparatus for gas-dynamic cold spraying a liner 3 in a cylinder 2 of an aluminum engine block 1 is provided. The gas-dynamic cold spray liner 3 allows the aluminum engine block 1 to have a hardened cylinder surface 10 without the induction of residual hoop stress within the aluminum engine block 1.

### FIELD OF THE INVENTION

The present invention relates to the art of providing liners for cylinder bores of internal combustion engine blocks. More particularly the present invention relates to a method and apparatus for forming such liners in aluminum engine blocks using a gas-dynamic cold spray technique.

### BACKGROUND OF THE INVENTION

In the most recent quarter century there has been a major effort to increase the fuel economy of automotive vehicles. To achieve increased fuel economy one technical trend has been a reduction in the weight of the vehicle. The heaviest component of most automotive vehicles is the engine block. In the past most engine blocks were fabricated from cast iron. Many engine blocks are now fabricated from cast alloy aluminum. Light aluminum alloy cast engine blocks present an opportunity to achieve significant weight reduction when compared to traditional cast iron engine blocks. However, to provide a compatible wear surface for the pistons operating within such engine blocks, iron cylinder liners are commonly used. These liners are placed within the engine block by being cast-in-place or by being locked by a shrink or interference fit. Cast-in-place liners (such as disclosed in U.S. Pat. Nos. 3,521,613 and 4,252,175) add complexity to the casting process and increase the cost and severity of foundry scrap. The interference fit process permits first the casting of blocks without liners, thus reducing the scrap concerns; the liner is inserted subsequently by extensive heating of the blocks to achieve an expansion, and then later cooling the block with the liner in place to achieve the interference fit between the cylinder bore and the liner. See U.S. Pat. No. 3,372,452.

To function properly, the inserted liners must have a full integral surface-to-surface bond that promotes thermal transfer as if the liner and cylinder bore were one unitary piece. However, some of the best material from a wear standpoint for lining the cylinder have the poor heat transfer characteristics or, in other words, have a high heat transfer resistance and therefore cannot be used. Also, the hoop stress that exists in the aluminum engine block, which is a result of an interference fit liner, can lead to high residual stresses in the engine block. To compensate for the residual stress within the engine block, the dimensioning of the engine block and the liner may be enlarged. The enlargement of the liner or he engine block adds to the weight of the engine block and works against the desired goal of increased fuel economy.

Another technique for providing liners in the cylinder bores of engine blocks has been by laser cladding or by thermal spraying. These two techniques have been found to be undesirable since they introduce residual stress into the base cast aluminum material.

It is desirable to provide a liner for aluminum engines which does not require a foundry casting operation. It is also desirable to provide a liner that will not induce residual stress within the aluminum cylinder block interference fits or thermal stress.

### SUMMARY OF THE INVENTION

To make manifest the above delineated and other manifold desires the revelation of the present invention is brought forth. In a preferred embodiment, the present invention provides a method of lining a cylindrical bore of a reciprocating piston internal combustion aluminum engine block. The cylindrical bore is lined utilizing a gas-dynamic cold spray to coat the cylinder bore with a lining material which differs from the material of the engine block. The engine block is first sprayed with the lining material which has good properties of adhesion and heat transfer with the aluminum engine block. A lining coating is then provided with a material having a higher level of hardness than the first lining material to minimize wear. The lining materials are sprayed into the cylinder bore longitudinally along the cylinder bore axis to prevent the generation of micro cracks which can hinder the proper transfer of lubricating oil upon the surface of the cylinder coat bore.

The present invention also provides a spray gun with a specialty nozzle that allows for the gas-dynamic cold spraying of the cylindrical bore. The present invention also provides an aluminum engine block having unique cylinder liners provided by a gas-dynamic cold spray.

It is an advantage of the present invention to provide a method of lining a cylinder of an aluminum internal combustion engine block with a material which differs from the material of the engine block without the requirement of a foundry operation, an interference fit, or a hot plasma spray.

Other advantages of the invention will become more apparent to those skilled in the art from a reading of the following detailed description and upon reference to the drawings.

### BRIEF DESCRIPTION OF THE DRAWINGS

FIG. 1 is a schematic view of an apparatus used to carry out certain essential steps of the inventive method.

FIG. 2 is a perspective view of a manufacturing apparatus of the present inventive method of gas-dynamic cold spraying to apply liners within the cylinder bores of an aluminum engine block.

FIG. 3 is an enlarged schematic sectional view of particles deposited in layers on a surface of a cylinder bore by the cold gas-dynamic spraying step of the present invention into a surface of the engine block cylinder.

FIG. 4 is a graphic illustration showing variation of mean velocity as a function of deposition efficiency for different metal particles as propelled by the supersonic nozzle.

FIG. 5 is a top plane view of a cylinder illustrating the engine block and the liner installed therein and also its finish machine surface profile.

FIG. 6 is a graphic profile illustrating the movement of the nozzle within the cylinder bore to spray deposit the lining thereon.

### DETAILED DESCRIPTION OF THE INVENTION

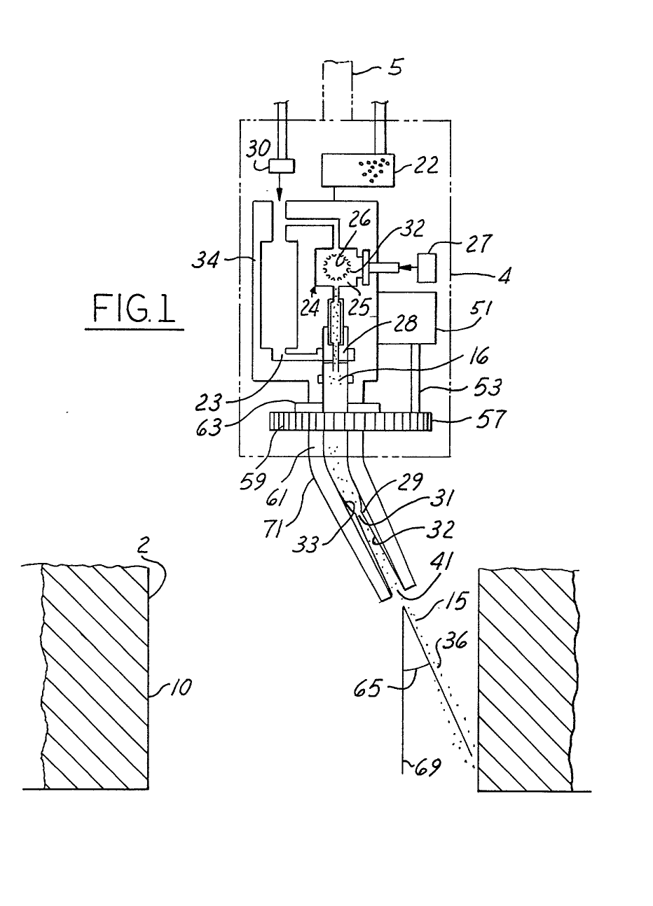

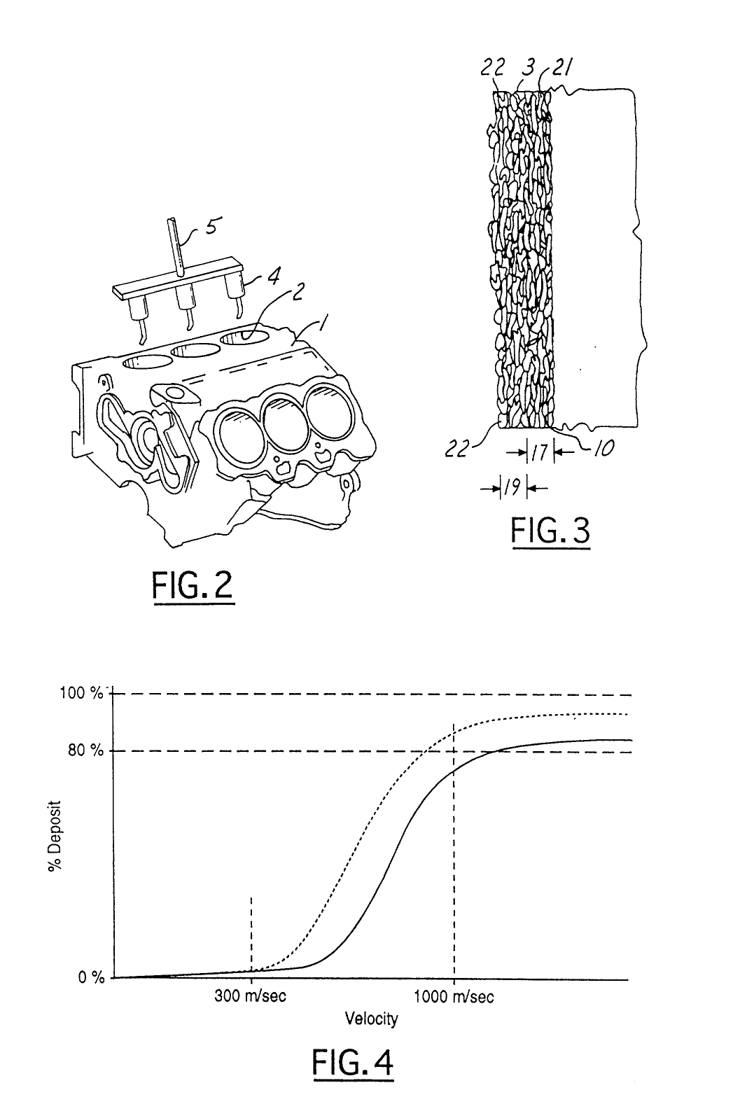

Referring to FIGS. 1, 2 and 3, a V-6 cast alloy aluminum engine block 1 is provided. The engine block 1 has two banks. Each bank has three cylinder bores 2. The cylinder bores 2 are provided for mounting reciprocating pistons therein to provide variable volume working chambers in a manner which is commonly known. The cylinder bores 2 are provided with a liner 3 (FIG. 3) having a material differing from that of the engine block 1 by utilizing a gas-dynamic cold spray. The gas-dynamic cold spray is supplied by a gas spray gun 4 to a surface 10 of the cylinder bores 2 in a manner to be described.

The spray gun 4 uses a relatively cold gas 16 to supersonically blow powder particles 15 (having a particle size in the range of 10-50 microns) against the cast aluminum cylinder bore surface 10 with sufficient kinetic energy and velocity (500-1500 m/s), and in an unmelted condition, to cause plastic deformation and consolidation of the particles 15 upon impact with the surface 10 by a phenomenon analogous to explosive welding. Such cold-gas spraying eliminates undesirable influences, characteristic of the plasma spray deposition, such as grain growth induced stresses, and existence of oxidation phases in the metal particles.

Different powder metal particles are applied in sequence; first, a first thermal management material layer 17 in which there is low level of heat resistance is deposited. The first material layer 17 will also have a high level of adhesion with the base aluminum material of the engine block 1. The spray gun 4 will spray the first material layer 17 in a thickness approximately 0.5 to 0.7 mm. After the first material layer 17 is deposited, a second wear resistant material layer 19 is deposited. The second material layer 19 is typically deposited in a thickness of 1.5 mm. giving a total applied lining thickness of approximately 2.0 mm. The second material layer 19 will typically be harder for purposes of wear resistance. Most of the materials which make up the second material layer 19 will have a higher heat resistance than the material which makes up first material layer 17 and also have a lower level of adhesion with the aluminum of the cylinder bore surface 10. The first material layer 17 must rapidly conduct heat between the second material layer 19 and the cast aluminum block base material to carry away combustion heat and frictional heat generated during use of the engine.

Metal particles 21 for the first material layer 17 are constituted primarily of copper or copper alloy, in the particle size range of 10-22 microns. Metal particles 22 for the wear resistant layer 19 are constituted at least primarily in a particle size range of 1-50 microns. From a practical standpoint, experience indicates that the powder particle size should be in the range of about 10-50 microns to be generally suitable for cold spray deposition. A high-pressure “bow” shock wave develops immediately adjacent to the target; this “bow shock” can begin to deflect and decelerate spray particles having a particle size below approximately 5 microns.

The material which makes up the wear resistant second material layer 19 can be taken from a group of materials consisting of nickelsel Ni—Si C; stainless steel; ceramic compounds; high carbon diamond-like materials; nodular irons (chilled); chrome; nitriting compounds; monel metals; or other suitable alternatives. The particles used for the wear resistant second material layer 19 must have the following process characteristics: wear resistance, hardness and properties typical or similar to that of tool steel material. Tool steel also admirably meets the aforementioned characteristics, as well as the aforementioned materials and other metal powders such as tungsten or tungsten alloys which provide somewhat similar benefits when mixed with tool steel particles. Tool steel is defined herein to mean a steel that has a composition with the following range of ingredients, by weight percent: C 0.3-1.5; Mn 0.25-1.6; Si 0.2-2.0; W 0.5-20.0; V 0.15-4.25; Mo 0.25-8.5; Co 0.6-12.0; Cr 0.3-12.0; Ni 0.3-12.0; and the remainder iron. Preferably H13 tool steel can be used which consists of C 1.0, Mn 1.0, Si 0.6, W 10.0, V 20 3.0, Mo 5.0, Co 6.0, Cr 6.0, Ni 6.0, and the remainder iron.

To carry out cold-gas metal spraying, the metal powders must be propelled at a necessary speed; a compressed gas propellant 23, of helium or helium and nitrogen mixed, is used. The solid metal powder particles are put into a 25 particle mixer and metering feeder 24 which presents a homogeneous mixture of metal particle sizes to a cylindrical drum 32. The drum 32 has surface depressions 26 that accept a predetermined quantity of the solid metal particles for transfer according to a metal powder controller 27. The conveyed stream of metal particles is mixed with the propellant gas 23 in a ratio of gas to metal particles sufficient to transfer the particles at high velocity; the mixture is delivered to the antechamber 28 of a supersonic nozzle 29. By changing the percentage of particles to gas, and/or increasing the temperature of the propellant gas, the velocity of the gas/particle jet exiting from the supersonic nozzle 29, can be varied.

With proper inlet gas pressure from a gas source 30 [i.e. 200-400 psi (2025-2700 kPa)], the gas flow velocity at the smallest internal diameter 31 of the converging/diverging nozzle 29, will be a local sonic velocity, at least mach 1. As the gas expands in the diverging section 32 of the nozzle, supersonic gas flow velocities are developed. As indicated earlier, powder particles are injected into the gas flow at the ante-chamber 28, upstream of the converging section 33 of the nozzle, and are accelerated by the surrounding gas flow to proceed down the nozzle.

To achieve a necessary critical particle velocity, the gas may be restricted to only helium, having a lower molecular weight, and by preheating the helium gas to reduce its density. Critical particle velocity is defined herein to mean 550-1000 m/s (for aluminum about 650 m/s). This critical impact velocity varies according to the material being sprayed as a deposit, but it should be somewhere in the range of 700-1100 m/s, preferably 800-1000 m/s, to obtain an 80% deposition efficiency (see FIG. 4). To achieve the elevated velocity, gas selection, gas pressure and particle size play a role. Lowering the gas pressure from 600 to 300 psi, when using helium, restricts the attainable velocity to larger and larger particle sizes. Changing to pure nitrogen, at a high pressure, results in further inability to spray smaller particles with sufficient velocity. Larger particles do not achieve as high an exit velocity as smaller particles do, even though the gas jet is at much higher velocities.

A 16-20 kW electrical resistance heater 34 is used to preheat the helium gas up to a temperature of 400-5500 C. It should be pointed out that the gas rapidly cools again as it expands and accelerates in the diverging section 32 of the nozzle 29, usually at a gas flow rate of 10-20 lbs/hr. Hence, the dwell time of the solid particles in contact with the heated gas is very brief, and temperature of the particles at impact (i.e. about 50 C.) is substantially below the gas preheat temperature to reduce the heat content transferred to the substrate.

Preheating the propellant gas creates a lower gas density which tends to reduce the drag force on the particles. Even though the maximum particle velocity may ultimately be higher with preheated gas, it may take a longer distance for the particles to closely approach the gas velocity, but are not highly sensitive to the precise internal geometry of the diverging section 32 of the spray nozzle 29. Therefore, a single nozzle design can be effectively used for a wide range of materials. The inlet gas pressure does not affect the gas velocity; however, increasing the inlet gas pressure does increase the gas density and thus provides better coupling of the particles to increase initial particle acceleration.

The nozzle 29, pre-heater 34, metering feeder 24 may all be contained in a gun assembly 4 movable by a robot positioner 5 for traversing the sprayed 36 particles on the surface 10 of the cylinder bore 2. The spray gun 4 is positioned so that the opening 41 of the nozzle is positioned along the axial centerline 44 of the cylindrical bore (FIG. 5). (Opening 41 is shown eccentrically off-center in FIG. 1 from its proper position for illustrative purposes.) Accordingly, the main body of the gun 4 will be displaced from the center.

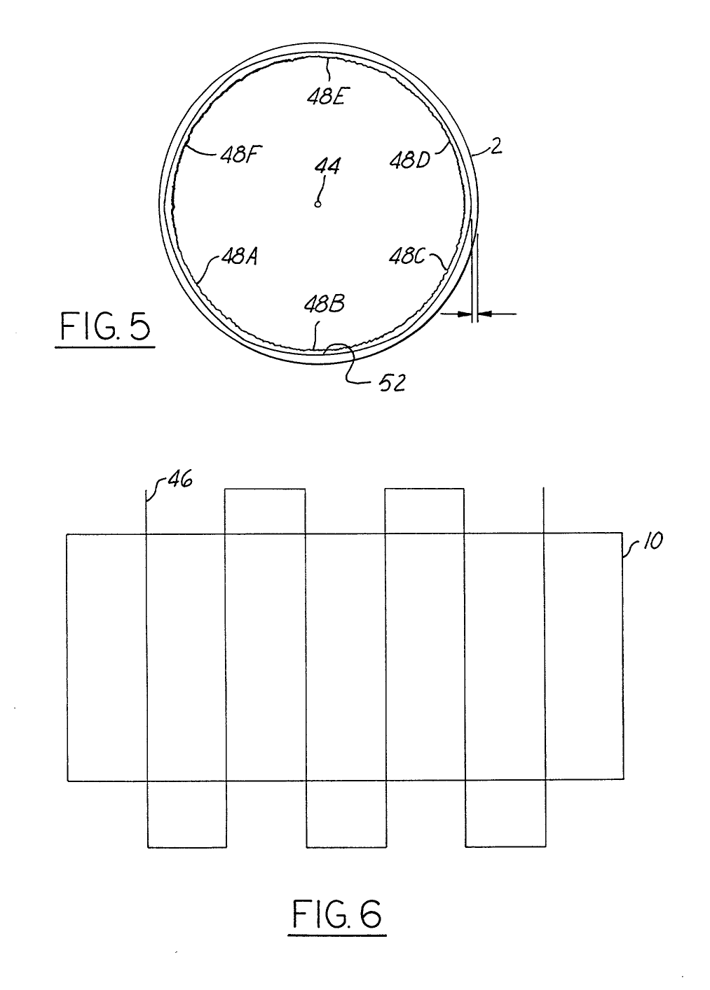

Referring additionally to FIGS. 5 and 6, the robot positioner 5 will move a plurality of guns 4. (For clarity of illustration, feed lines for particles and gas are removed in FIG. 1.) In a reciprocating motion, as best shown by travel diagram line 46 traversing longitudinally up and down in a line parallel with the axis 44 of the cylinder bore 3, the spray pattern is longitudinal in the cylinder bore 2 in segments 48A through F. The segments 48 may overlap if desired. Longitudinal spraying of the bore surface 10 ensures that any micro cracks that may develop in the liner 3 will be longitudinal and therefore oil will not be prevented from flowing up and down the cylinder bore 2 for proper lubrication after subsequent wear of the liner. After the spraying operation, the lined cylinder surface 10 will be machined to a surface 52 providing a liner of approximately 1.5 mm. thickness.

The spray gun 4 has a motor 51 with a connected shaft 53. At the end of the shaft 53 is a gear 57 which is in mesh with another gear 59. The gear 59 rotates a lower barrel 61 of the gun about a coupling 63 to allow the lower barrel 61 to rotate. Therefore, the robotic positioner 5 can traverse the spray gun 4 longitudinally in and out the cylinder bore 2 and the opening of the gun 41 can spray the cylindrical bore surface 10 along the aforementioned segments 48. The cold, gas-dynamic spray 36, upon exiting the gun 4 comes out in an angle 65 which is approximately 30° from a line 69 which is parallel to the longitudinal center axis 44 of the cylinder bore 2. As mentioned previously, to provide the most even coating possible, the spray gun opening 41 will be positioned intersecting the center axis 44 as best shown in FIG. 5. The converging, diverging nozzle 29 is positioned after the bend 71 in the lower barrel 61. The particles slightly slow along the bend 71. Accordingly, the nozzle 29 is after the bend 71 so that the particles can be accelerated to the maximum velocity possible at the opening 41.

The precise mechanism by which solid particles deform and bond to the aluminum base is evident when a minimum critical velocity for the cold spray deposition takes place. A solid particle of copper that has been sprayed, impacts the cylinder bore surface 10 and not only plastically deforms itself but also initially indents the surface 10 while pushing waves of the aluminum base material to the sides. Plastic deformation of the incident particle, as well as the underlying surface, disrupts any thin surface aluminum oxide which has formed on the surface. Hence, clean metal surfaces are always brought into intimate conformal contact at high localized impact pressures. The metal particles spherical particle, impact a locally flat surface of the cylinder bore 10, ideally resulting in a progressively expanding circle of contact that “sweeps” other surface impurities away from the particle-substrate interface. The deformation proceeds to a stage where the metal particle merges into the cylindrical bore surface 10 with little of the particles appearing above the cylindrical bore surface 10 while producing essentially no porosity (i.e. 2% or less). This bonding process is similar to forge welding or explosive welding. The available energy at impact must be sufficient to cause requisite plastic deformation for such explosive welding to take place. Computational modeling and micro-structural evidence shows such plastic deformation of impacting cold spray particles take place with the underlying aluminum base material. Calculated and experimental results corroborate that no local melting occurs during such cold spray conditions. Indeed, the peak local temperatures predicted are below the melting point of the metals used. A great advantage of this process is that oxygen-sensitive materials can be sprayed in an ambient-air environment without significant oxidation. Cold sprayed copper show no obvious oxide in the deposit and have much less porosity.

Turning to FIG. 3, the plastically deformed and layered particles look like “splats” under magnification. The thermal layer metal particle splats 21 (of layer 17) are covered by wear resistant metal particle splats 22 (layer 19). Such “splats” in the cold-sprayed deposit show sharp angular boundaries, with no apparent evidence of localized melting, even at much higher magnifications.

If the spray of particles is concentrated to a smaller diameter, even greater detail and accuracy can be obtained in achieving a uniform wear resistant coating. To this end, as taught in commonly assigned U.S. patent application Ser. No. 09/624,926 filed Jul. 25, 2000, entitled “METHOD OF MAKING RAPID PROTOTYPE TOOLING HAVING FREE-FORM SHAPE”, the disclosure of which is incorporated by reference herein, an aerodynamic focusing element can be used upstream of the supersonic nozzle and performs essentially as a means of slowing down the particle-laden gas stream through a flow constriction. As the gas carrying the solid particles converges toward the centerline upstream of the constriction, particles are accelerated toward the centerline axis by the radially inward component of the flow. As the gas decelerates radially, inertia causes the solid particles to continue to move toward the centerline. The expansion of the flow as it exits the constriction is more gradual, and the particles are not strongly accelerated away from the centerline. The net result is that particles downstream of the aerodynamic focusing constriction occupy a streamline closer to the centerline than the streamline they occupied upstream of the aerodynamic constriction. The degree of focusing is determined by how much closer to the centerline is the final particle.

Depending upon factors such as the flow velocity, the diameter of the constriction, gas viscosity and mass density, particle size, and the initial radial position of the solid particle, different degrees of focusing will occur. This subcritical velocity focusing can be further improved by using multiple constrictions in series to progressively move the particles closer to the central axis. Thus, with the aerodynamically focused powder stream and with the supersonic nozzle held at an angle, with respect to a perpendicular to the local surface, of about O′, maximum impact and control can be obtained.

To enhance coating effectiveness as a continuous coherent and well-bonded, wear resistant coating, the particles of copper and wear liner material may be blended as a transient gradient between the thermal management layer of copper and the wear resistant layer of wear resistant material. If the wear resistant material is tool steel, smaller steel particles (less than 5 microns) net more readily with the larger copper particles (10-45 microns) to avoid any possible inter-splat boundaries to enhance the integrity of the coating.

While the invention has been described in connection with a preferred embodiment, it will be understood that it is not intended to limit the invention to that particular embodiment. On the contrary, it is endeavored to cover all embodiments, modifications and equivalents as may be included within the spirit and scope of the invention as encompassed by the description and as defined by the appended claims.

We claim:

1. A method of lining a cylinder bore of a reciprocating piston internal combustion engine aluminum engine block comprising:
spraying said cylinder bore with a gas-dynamic cold spray to coat said cylinder bore with a lining material differing from a material of said engine block.

2. A method as described in claim 1, further including initially coating said cylinder bore with a first material having a first level of heat transfer resistance, and then coating said cylinder bore with a second material having a second level of heat transfer resistance greater than said first level.

3. A method as described in claim 1, further including first coating said cylinder bore with a first material having a first level of adhesion with said aluminum of said engine block, and then coating said cylinder bore with a second material having a second level of adhesion lower than said first material, and said second material having a hardness greater than said first material hardness.

4. A method as described in claim 2, further including first coating said cylinder bore with a first material having a first level of adhesion with said aluminum of said engine block, and then coating said cylinder bore with a second material having a hardness greater than said first material hardness.

5. A method as described in claim 1, utilizing a nozzle to spray said lining material and wherein said nozzle and said cylinder bore of said engine block have relative movement with respect to one another.

6. A method as described in claim 5, wherein said nozzle is translated up and down through said cylinder bore.

7. A method as described in claim 6, wherein said nozzle is positioned along a longitudinal center axis of said cylinder bore.

8. A method as described in claim 5, wherein said nozzle is angled at 30° plus or minus 15° from a surface of said cylinder bore.

9. A method as described in claim 5, wherein said cylinder bore is coated in multiple passes.

10. An internal combustion engine comprising:
an aluminum engine block having at least one cylinder bore for mounting a reciprocating piston therein; and
a lining of said cylinder bore of a material differing from a material of said engine block, said material being provided by a gas-dynamic cold spray.

11. An internal combustion engine as described in claim 10, wherein said cylinder bore lining includes a first lining material and a second lining material.

12. An internal combustion engine as described in claim 11, wherein said second lining material is harder than said first lining-material.

13. An internal combustion engine as described in claim 11, wherein said first lining material has better adhesion with said aluminum block than said second lining material.

14. An internal combustion engine as described in claim 11, wherein said first lining material has less heat resistance than said second lining material.

15. An internal combustion engine as described in claim 12, wherein said second lining material has less heat resistance than said first lining material.

16. An internal combustion engine as described in claim 1, wherein said lining is applied axially within said cylinder bore.

17. A spray gun for spraying a cylinder bore of an aluminum engine block with a gas-dynamic cold spray to coat the cylinder bore with a lining material, the apparatus comprising:
a metering feeder;
a supersonic nozzle, said nozzle being angled at 30° plus or minus 15° of an axis of said cylinder bore.

18. A spray gun as described in claim 17, wherein said nozzle can be rotated.

19. An apparatus as described in claim 17, wherein said lining material is first accelerated generally parallel with the longitudinal axis of said cylinder and, said lining material is then angled at said 30° plus or minus 15° angle and said material then passes through said nozzle before exiting said spray gun.
